(19) United States
(12) Patent Application Publication
(10) Pub. No.: US 2005/0155594 A1
(43) Pub. Date: Jul. 21, 2005

(54) Device for pushing a carriage for an abrasive cutting-off machine

(76) Inventors: Helmut Patzke, Glinde (DE); Manfred Doring, Hamburg (DE)

Correspondence Address: Marlana Titus;Nash & Titus, LLC, 6005 Riggs Road, Laytonsville, MD, 20882, US

(21) Appl. No.: 11/037,667

(22) Filed: Jan. 18, 2005

(30) Foreign Application Priority Data
Jan. 19, 2004 (DE) 20 2004 000 783.5

(51) Int. Cl. B28D 1/04

(52) U.S. Cl. 125/13.01

(57) ABSTRACT

This invention entails a guide device, especially for use with abrasive cutting-off machines, which has at least one rolling means for rolling the guide device substantially by the body power of a user. The guide device has at least one handle arranged opposite the rolling means for transferring a force exerted by the arms of the user onto the handle. The device is characterized by a pushing element for transferring a force exerted by another body part of the user, in particular the thigh, onto the guide device.

### FIELD OF THE INVENTION

The invention relates to a guide device, especially for abrasive cutting-off machines, with rolling means for rolling the guide device substantially by the body power of a user and with a handle arranged opposite the rolling means for transferring a force exerted by the arms of the user onto the handle.

### BACKGROUND OF THE INVENTION

Guide devices can be, e.g., carriages for abrasive cutting-off machines. Carriages for abrasive cutting-off machines are known in the state of the art. A generic carriage for abrasive cutting-off machines is disclosed, e.g., in DE 198 39 341. In order to place, e.g., rather long and straight expansion joints in concrete surfaces or straight cut lines in road surfaces, hand-guidable abrasive cutting-off machines are mounted on such a carriage for abrasive cutting-off machines. The carriage for abrasive cutting-off machines is pushed and guided by a user walking substantially upright via a handle rod arranged at the arm level of the user.

The known carriages for abrasive cutting-off machines were found to have the disadvantage that the vibrations caused by the abrasive cutting-off machine and transferred to the carriage for abrasive cutting-off machines result in a rapid tiring of the user's arms. Furthermore, the disadvantage was found that in the case of too great an advance by the user the carriage for abrasive cutting-off machines rotates about the abrasive disk sunk in the concrete and therefore the wheels can briefly become loose from the ground. This makes it difficult to cut in a straight line.

### SUMMARY OF THE INVENTION

The present invention addresses the problem of making available a guide device in particular for abrasive cutting-off machines that avoids the cited problems.

The problem is solved by a generic guide device comprising a pushing element for transferring a force exerted by another body part of the user, in particular the thigh, onto the guide device.

### BRIEF DESCRIPTION OF THE FIGURES

FIG. 1 shows a perspective view of a carriage for abrasive cutting-off machines in accordance with the invention.

FIG. 2 shows an exploded view of another carriage for abrasive cutting-off machines in accordance with the invention.

FIG. 3 shows a perspective view of another carriage for abrasive cutting-off machines in accordance with the invention with mounted abrasive cutting-off machine and tank.

### DESCRIPTION OF THE PREFERRED EMBODIMENTS

The guide device is guided and pushed by the body power of the user in that the user grasps the at least one handle and guides and pushes the device with the aid of the handle. This manner of moving the guide device rapidly tires the arms of the user, in particular in the case of mounted and running abrasive cutting-off machines. With the pushing element of the invention the force required to move the device can be applied by other body parts of the user, in particular the thigh or thighs. The guide device can be guided and pushed with the other body part by the additional attack point and in the meantime the arms of the user can recover.

To this end the pushing means should advantageously be arranged at a height a short distance above the knee of the user. In this manner the guide device can be easily pushed with at least one thigh of the user while removing the stress from his upper body. In addition, better lever relationships on the guide device result from the arranging of the pushing means in the vicinity of the rolling means opposite the handle. During operation a cutting disk rotating on the mounted abrasive cutting-off machine cuts into the ground to be worked. A point of rotation is produced thereby in the area of the cutting disk about which point the mounted device rotates when the advance by the user is too strong. Given the same application of force by the user on either the handle or on the pushing element the rolling means come loose from the ground more in the first instance than in the second instance since the lever arm in the first instance is longer. As a result of the shorter lever arm of the pushing element of the invention the guide device varies its adherence to the ground more infrequently and remains guidable even given a rather strong advance.

The guide device of the invention can be readily operated when the pushing element on the user side of the guide device forms a support for the other body part which support can make contact with the user's body part when the user rolls the guide device. As a consequence of the support, the course of movement that the user is accustomed to remains substantially retained in that he presses against the support when walking in the direction of guiding.

In an advantageous embodiment of the invention the pushing element comprises a push rod arranged transversely to a connection line between the handle and the rolling means. Push rods can be readily manufactured and are nevertheless sufficient for transferring the advance force of the user onto the guide device. The push rod is preferably designed as a tube in order to save material.

In guide devices with a carriage frame the pushing element can be integrated in the carriage frame. In this instance a transverse rod, in particular a transverse tube, advantageously runs out from a frame rod on the handle side.

The pushing element can also be arranged in an adjustable manner on the carriage frame in the cited guide devices. An adjustment means is preferably arranged between a push rod and the carriage frame and makes possible a continuous adjustment of the position of the push rod on the carriage frame.

In a preferred embodiment the carriage frame comprises an articulation with an articulation bolt and the holder comprises a borehole for running the articulation bolt through it. This forms an adjustment means that is simple and therefore insensitive to disturbances. In addition, the push rod can be mounted by the holder on a carriage frame that is only slightly modified by lengthening the articulation bolt by the thickness of the holder. This makes possible an economic conversion of the invention.

In another preferred embodiment of the invention a push element projects on the user side from a tank arranged on the rolling-means side of the handle. The tank can be designed in one piece with the push element as an injected molded part and be suspended in a suspension of a traditional guide device which suspension is known in the state of the art.

In order that the guide device meets all valid health standards the pushing element can comprise a buffering, e.g., a vibration protection. In particular, a push rod can be surrounded by a foam jacket to this end. As a result thereof, vibrations produced by the running abrasive cutting-off machine are transferred only in a dampened manner onto the user, especially onto his thigh.

The invention also relates to the push rod for a carriage for abrasive cutting-off machines, which carriage comprises a projecting holder with a borehole running parallel to a longitudinal axis of the push rod and for an articulation bolt of an articulation of a carriage frame of the carriage for abrasive cutting-off machines.

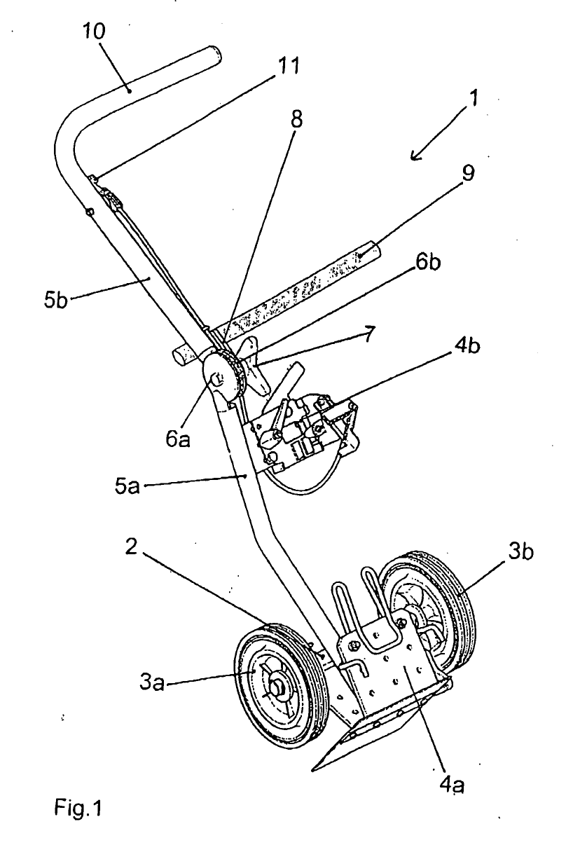

The invention will be described in an exemplary manner using three figures, FIGS. 1, 2 and 3, as described herein.

Carriage for abrasive cutting-off machines 1 comprises two wheels 3a, 3b connected by wheel shaft 2 on a wheel-side end. Receptacle 4a for an abrasive cutting-off machine is provided between wheels 3a, 3b. Wheel-side receptacle 3 is connected via carriage frame 5a, 5b to handle rod 10 arranged parallel to wheel shaft 2 connecting both wheels 3a, 3b. Carriage frame 5a, 5b comprises frame rod 5b on the handle side and frame rod 5a one the wheel side connected to one another by cogging 6a, 6b in an articulated manner. Cogging 6a, 6b can be adjusted by wing screw 7 and permits gradual angular adjustments of wheel-side frame rod 5a and of handle-side frame rod 5b relative to one another. Wheel-side frame rod 5a comprises cogging-side receptacle 4a one its cogging-side end section for abrasive cutting-off machine 1 (not shown).

Holder 8 is mounted between cogging 6a, 6b and wing nut 7 and connects push rod 9 of the invention to carriage frame 5a, 5b. Push rod 9 runs parallel to handle rod 10 and parallel to wheel shaft 2. Push rod 9 and holder 8 are designed in one piece here.

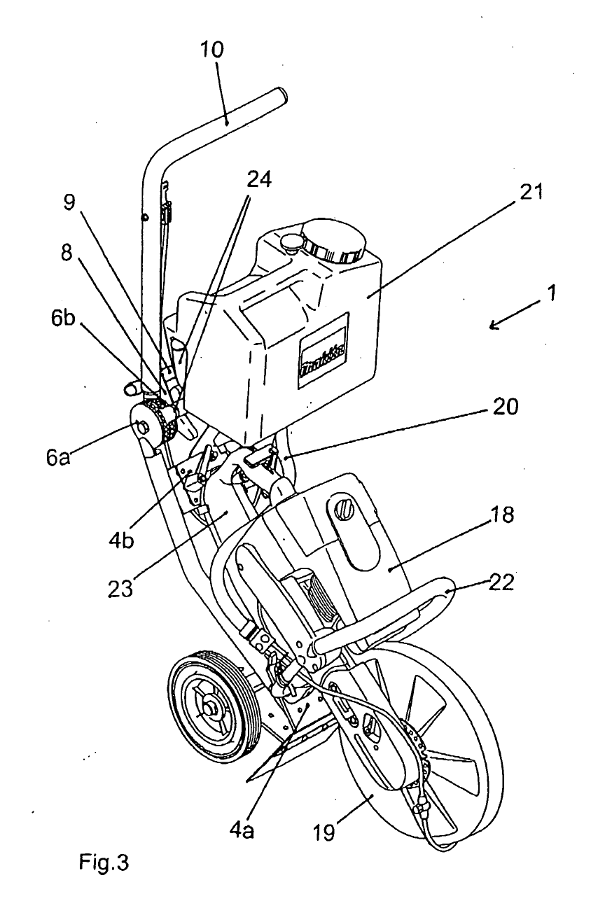

Wheel-side receptacle 4a and cogging-side receptacle 4b are suitable for mounting an abrasive cutting-off machine, as is shown in FIG. 3, on carriage frame 5a, 5b.

Control lever 11 of a control for the abrasive cutting-off machine is provided on carriage frame 5a, 5b on handle-side frame rod 5b slightly below handle rod 10 toward the wheel side.

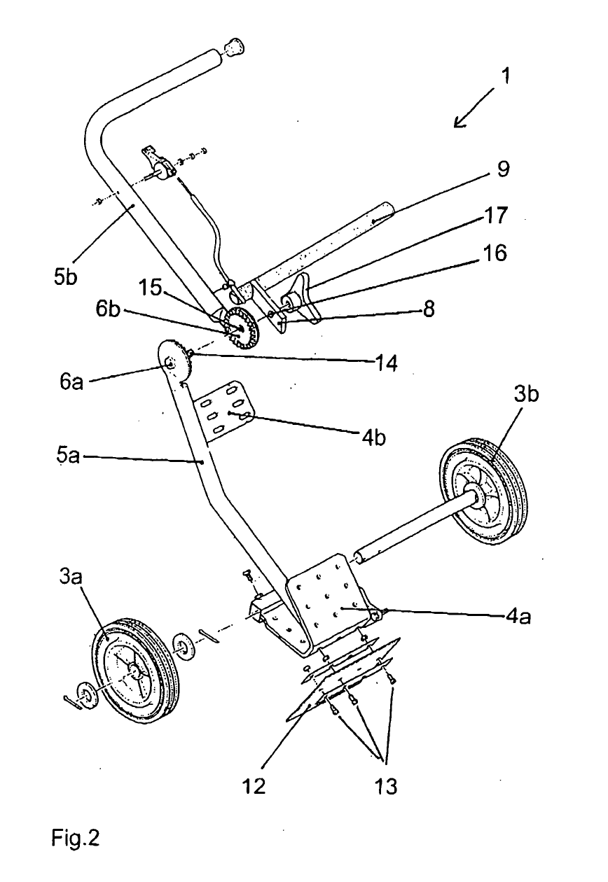

The exploded view of carriage for abrasive cutting-off machines 1 of FIG. 1 shown in FIG. 2 does not completely show wheel-side receptacle 4a and cogging-side receptacle 4b. Wheel-side frame rod 5a and protective plate 12 are screwed to wheel-side receptacle 4a by screws 13. FIG. 2 shows the articulation mechanism of cogging 6a, 6b between wheel-side frame rod 5a and handle-side frame rod 5b. A first gear ring 6a with centrally arranged articulation bolt 14 is designed on the cogging-side end of wheel-side frame rod 5a the longitudinal axis of which ring is arranged vertically to the longitudinal axis of the cogging-side section of wheel-side frame rod 5a. Gear ring 6b complementary to the first gear ring 6a and with central borehole 15 for articulation bolt 15 is provided on the cogging-side end of handle-side frame rod 5b.

Holder 8 of push rod 9 comprises borehole 16 on an end opposite push rod 9 for articulation bolt 14. In the assembled carriage for abrasive cutting-off machines 1 complementary gear ring 6b is arranged between gear ring 6a and holder 8. Articulation bolt 14 has an outside threading on its end projecting from first gear ring 6a which threading cooperates with wing nut 17. Wheel-side and handle-side frame rods 5a, 5b can be locked in certain relative angular positions by tightening wing nut 17. On the other hand, borehole 15 of holder 8 has no inside threading. Thus, push rod 9 integrally formed with holder 8 can pivot continuously in an arc about articulation bolt 14 and be fixed in any desired position there by wing nut 16. Thus, the position of push rod 9 is also height-adjustable in a section determined by the arc above the ground on which the carriage for abrasive cutting-off machines is located. Wheels 3a, 3b are not in contact with the ground to be worked by the abrasive cutting-off machine during the operation of the abrasive cutting-off machine (not shown). The height of push rod 9 above the ground is advantageously selected in such a manner that push rod 9 is positioned slightly above the knee of the user, who pushes carriage for abrasive cutting-off machines 1 in front of himself in a basically upright position of the body.

FIG. 3 shows abrasive cutting-off machine 18 mounted on carriage for abrasive cutting-off machines 1. Abrasive cutting-off machine 18 comprises

1-9. (canceled)

10. A guide device comprising
at least one rolling means for rolling the guide device substantially by the manual power of a user,
at least one handle arranged opposite the rolling means for transferring a force exerted by the arms of the user onto the handle, and
a pushing element for transferring a force exerted by the lower body of the user onto the guide device.

11. The guide device according to claim 10, wherein the pushing element transfers force exerted by at least one thigh of the user, onto the guide device.

12. The guide device according to claim 10, wherein the pushing element on the user side of the guide device forms a support for the lower body which support can make contact with the lower body when the user rolls the guide device.

13. The guide device according to claim 10, wherein the pushing element comprises a push rod arranged transversely to the connection line between the handle and the rolling means.

14. The guide device according to claim 13, which further comprises a carriage frame on which the pushing element is arranged.

15. The guide device according to claim 14, which further comprises an adjustment means arranged between the push rod and the carriage frame.

16. The guide device according to claim 15, which further comprises a holder connecting the push rod to the carriage frame, which holder comprises a borehole, and wherein the carriage frame comprises an articulation with an articulation bolt for running through the borehole.

17. The guide device according to claim 14, wherein the pushing element is integrated into the carriage frame.

18. The guide device according to claim 10, wherein the handle comprises a rolling-means side, which guide device further comprises a tank arranged on the rolling-means side of the handle, wherein the tank projects the pushing element on the user side.

19. The guide device according to claim 10, wherein the pushing element is surrounded at least partially by an elastic material.
